(19) United States
(12) Patent Application Publication
(10) Pub. No.: US 2008/0001416 A1
(43) Pub. Date: Jan. 3, 2008

(54) Energy absorbing bumper assemblies and methods for absorbing kinetic energy during an impact event

(76) Inventors: Tansen Dhananjay Chaudhari, Bangalore (IN); Stephen Shuler, Royal Oak, MI (US); Robert Franklin Nelson, Brighton, MI (US); Ashwit Dias, Bardez (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/479,063

(22) Filed: Jun. 30, 2006

(51) Int. Cl. B60R 19/18

(52) U.S. Cl. 293/120

(57) ABSTRACT

Bumper assemblies for vehicles include multiple spaced apart layers formed of a polymeric material. In one embodiment, the polymeric layers are arranged such that a thickness gradation of the layers exists, wherein the thinnest layers are positioned to provide (and absorb a portion of the kinetic energy associated therewith) the initial impact surface. In another embodiment, the polymeric layers are arranged such that a modulus property gradation of the layers exists, wherein the layers having the lowest modulus property are positioned to provide the initial impact surface. Since the bumper assembly is formed of polymeric materials, the resulting mass is approximately one half that of a conventional bumper assembly. Moreover, the polymeric bumper assembly can be easily extruded and is recyclable.

### BACKGROUND

The present disclosure generally relates to a bumper assembly and more specifically, to a bumper assembly formed of a plurality of energy absorbing layered media.

A known standard which bumper systems often are designed to meet is the United States Federal Motor Vehicle Safety Standard (FMVSS). For example, some energy-absorbing bumper systems attempt to reduce vehicle damage as a result of a low speed impact by managing impact energy and intrusion while not exceeding a rail load limit of the vehicle. In addition, some bumper systems attempt to reduce pedestrian injury as a result of an impact.

A bumper system typically includes a beam that extends widthwise across the front or rear of a vehicle and is mounted to rails that extend in a lengthwise direction. The beam typically is steel and provides structural strength and rigidity. To improve the energy absorbing efficiency of a bumper system, some bumper systems also include shock absorbers. The efficiency of an energy absorbing bumper system, or assembly, is defined as the amount of energy absorbed over distance, or the amount of energy absorbed over load. A high efficiency bumper system absorbs more energy over a shorter distance than a low energy absorber. High efficiency is achieved by building load quickly to just under the rail load limit and maintaining that load constant until the impact energy has been dissipated.

Typically, bumper assemblies are designed to absorb most of the kinetic energy associated with an impact event with other objects, including vehicles, stationary objects or pedestrians, so as to minimize damage to the passengers and the pedestrians. Conventional energy absorbers have been manufactured using expanded foam or thermoplastic materials attached to a metal beam. The energy absorbers used in bumpers are required to provide safety-enhancing levels of energy absorption for collisions at impact speeds of about 40 km/hour and to minimize potential damage to pedestrians in low speed collisions between vehicles and pedestrians. Further, compliance with industry regulations, for example the need to provide adequate deformation in low speed collisions to minimize potential damage to pedestrians, and to provide a high barrier force in case of high-speed impact presents significant challenges to conventional metal or plastic bumpers. Further, modern energy absorbing systems must cope with complex situations such as multiple impact collisions wherein a second impact occurs on a previously deformed bumper. Typical energy absorbers (EA) occupy large volumes, which in some cases, is undesirable due to vehicle styling trends such as “low-offset bumpers”.

To meet today's rigorous safety standards while satisfying the requirements of current vehicle styling trends there exists a need for energy absorbing bumper assemblies that are lightweight and of a low volume, and which provide better resistance to deformation and higher collision impact energy absorption than currently available energy absorbing systems. In general, there exists a need for energy absorbing bumper systems capable of absorbing more energy at a lower mass, both within automotive applications and non-automotive applications.

### BRIEF SUMMARY

Disclosed herein are bumper assemblies and methods of use. In one embodiment, the bumper assembly in combination with a vehicle for absorbing kinetic energy associated with an impact event comprises a plurality of spaced apart polymeric layers configured to have a thickness gradation, wherein the thickness gradation consists of having the polymeric layer with the smallest thickness dimension as an initial impact surface

In another embodiment, the bumper assembly in combination with a vehicle for absorbing kinetic energy associated with an impact event comprises a plurality of spaced apart polymeric layers configured to have a modulus property and/or Poisson's ratio gradation, wherein the modulus property and/or Poisson's ratio gradation consists of having the polymeric layer with lowest modulus property and/or the highest Poisson's ratio as an initial impact surface.

A method for absorbing kinetic energy from an impact event on a bumper assembly of a vehicle comprises configuring the bumper assembly to have a plurality of spaced apart polymeric layers and sequentially arranged to have a selected one of a thickness gradation, a Poisson's ratio gradation, a flexural modulus gradation and combinations thereof, wherein the thickness gradation consists of positioning the polymeric layer with the smallest thickness dimension as an initial impact surface and wherein the modulus property and/or Poisson's ratio gradation consists of having the polymeric layer with lowest modulus property and/or the highest Poisson's ratio as an initial impact surface: and absorbing energy from an impact event on the impact surface

The above described and other features are exemplified by the following Figures and detailed description.

### BRIEF DESCRIPTION OF THE DRAWINGS

FIG. 1 illustrates a perspective view of an exemplary bumper assembly in accordance with one embodiment of the disclosure;

FIG. 2 illustrates a sectional view taken along lines 2-2 of the bumper assembly of FIG. 1;

FIG. 3 illustrates a top down sectional view of an exemplary bumper assembly in accordance with another embodiment of the disclosure; and

FIG. 4 illustrates a top down sectional view of an exemplary bumper assembly in accordance with yet another embodiment of the disclosure.

### DETAILED DESCRIPTION

Disclosed herein is a lightweight energy absorbing bumper assembly for vehicles. Generally, the bumper assembly is formed of multiple layers of a polymeric material spaced apart from one another with spacers. The polymeric layers are arranged such that a thickness gradation of the layers exists, wherein the thinnest layers are positioned to provide (and absorb a portion of the kinetic energy associated therewith) the initial impact surface. In the event of an impact event, the thus configured layers sequentially absorb compressive forces from the impact event. Advantageously, the bumper assembly provides improved deformation in low speed collisions, thereby minimizing potential damage to pedestrians, other vehicles, and the like. Since the bumper assembly is formed of polymeric materials, the resulting mass is approximately one half that of a conventional bumper assembly. Moreover, the polymeric bumper assembly can be easily extruded and is recyclable. Suitable polymers include, but are not limited to, thermoplastics, thermoplastic elastomers, thermosets, and the like.

In an alternative embodiment, multiple polymeric layers having similar thicknesses are separated by spacers. The layers are arranged to provide a flexural modulus and/or Poisson ratio's gradation similar to that discussed immediately above such that the most flexible polymeric layer (e.g., highest Poisson's ratio and/or flexural modulus properties) is positioned to provide the initial impact surface. As used herein, the term “Poisson's ratio” refers to a measure of the simultaneous change in elongation and in cross-sectional area within the elastic range during a tensile or compressive event. The various bumper assemblies disclosed herein provide the covering of a rigid structural assembly of the vehicle so that certain government standards can be maintained. The structural assemblies are generally formed of rigid aluminum or steel and because these assemblies are well known in the art they will not be discussed herein. Advantageously, the bumper assemblies disclosed herein can be shaped to accommodate and are adapted to attach to the structural assembly.

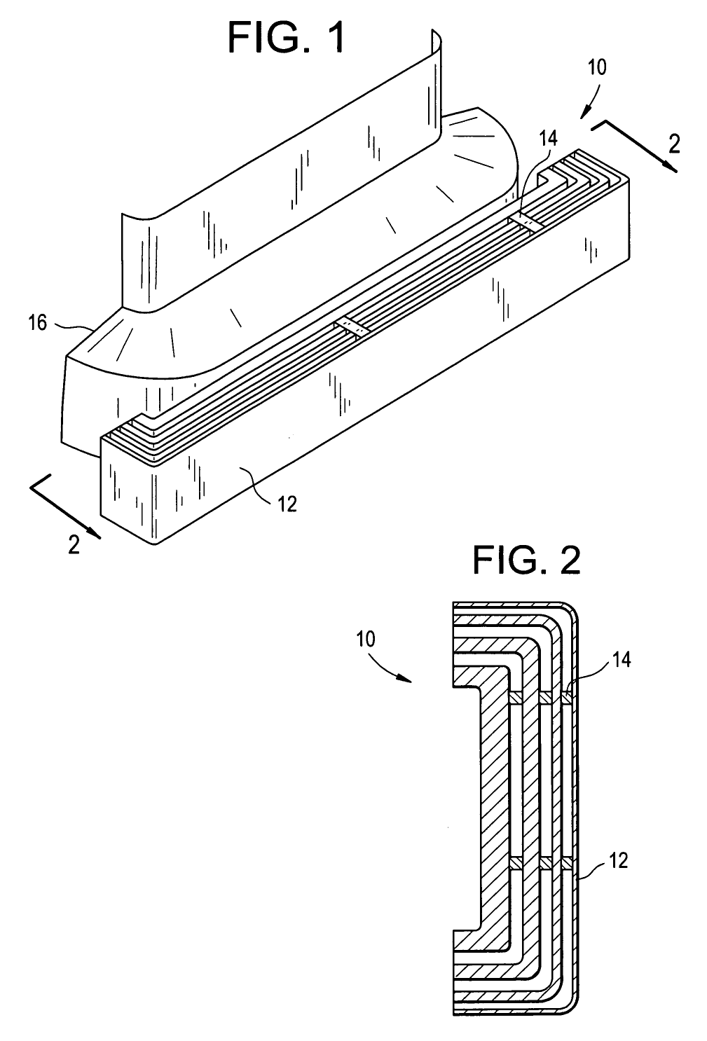

FIGS. 1 and 2 illustrate various views of a bumper assembly 10 in accordance with one embodiment. The illustrated bumper assembly 10 generally includes multiple polymeric layers 12 sequentially arranged by thickness and spaced apart from one another with a spacer 14. Multiple spacers 14 can span across length of the bumper. Although 4 layers 12 are shown, it should be apparent that more or less layers are contemplated and well within the scope of the present disclosure. In the illustrated embodiment, each layer 12 is selected to have a different thickness with the thinnest layer selected to provide the initial impact surface. The bumper assembly is positioned in front of a rigid barrier formed of a substantially inflexible material, e.g., a steal beam, an aluminum beam, or the like. The spacers 14 are in the form ribs and provide rigidity and support to the bumper assembly as well as providing spacing between layers. The spacing can be constant or can vary as may be desired for different applications.

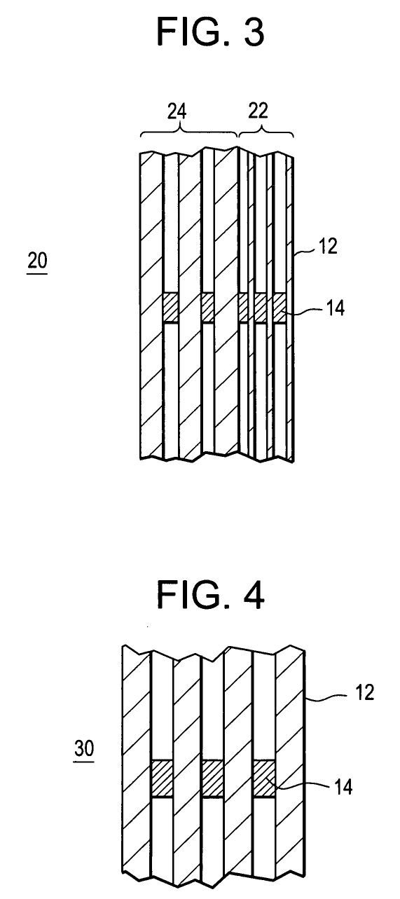

In another embodiment as shown in FIG. 3, the bumper assembly 20 includes a first set 22 of multiple spaced apart polymeric layers 12 having a first fixed thickness dimension followed by a second set 24 of multiple spaced apart polymeric layers having a second thickness fixed dimension, wherein the first thickness is less than the second thickness and the polymeric layers 12 with the first thickness dimension are positioned to provide the initial impact surface. Additional sets of polymeric layers of increasing thickness can be added as may be desired for different applications.

In another embodiment as shown in FIG. 4, the bumper assembly 30 includes multiple spaced apart polymeric layers 12 have the same fixed thickness dimension. The elastic modulus and/or Poisson's ratio for each polymeric layer is selected to sequentially vary with the lowest modulus property layer (i.e., most elastic) and/or highest Poisson's ratio positioned to provide the initial impact surface.

The characteristics of the material utilized to form the polymeric layers include, but are not limited to, high toughness/ductility, thermally stable, high-energy absorption capacity, a good modulus-to-elongation ratio and recyclability. While the energy absorber may be molded in segments, the absorber also can be of unitary construction made from an extruded plastic material. An example material for the absorber is Xenoy material, as referenced above. Of course, other engineered thermoplastic and thermoset resins can be used. In some instances the article may comprise a combination of one or more thermoplastic materials and one or more thermoset materials. And one or more elastomers. Polymeric materials suitable for use according to the present disclosure include, but are not limited to, polycarbonate-ABS blends (PC-ABS blends), polycarbonate-poly(butylene terephthalate) blends (PC-PBT blends), polyphenylene ethers, blends comprising polyphenylene ethers, polyethylenes, (high density and low density linear polyethylenes) polyalkylenes (for example polypropylenes, and polyethylenes), polycarbonates, polyamides, olefin polymers, polyesters, polyestercarbonates, polysulfones, polyethers, polyetherimides, polyimides, silicone polymers, acrylates (homo and co-polymers), mixtures of the foregoing polymers, with elastomers, copolymers of the foregoing polymers, and various mixtures thereof. Certain embodiments utilize bisphenol-A polycarbonate as the plastic material. In one embodiment the plastic material is XENOY, a polymer blend comprising polycarbonate and poly(butylene terephthalate) available from GE Plastics.

In a yet another embodiment, the bumper assembly includes layers formed of at least one composite material. The composite material may comprise thermoset or thermoplastic or thermoplastic elastomers materials. Other materials that may be used in the composite material include other polymers, glass fibers, carbon fibers, aramid fibers, carbon nanotubes, metal powders, metals, intermetallics, organoclays, inorganic clays, ceramics, or any combination of the above. The fibers, as discussed, include short fibers which can be injection molded. Composite material types include, continuous fiber composites, chopped strand mat composites, woven fabric composites, three-dimensional fabric based composites and the like. “Composite materials” as used herein, also includes materials that are meso- or nano-level mixtures of organic compounds, for example, polymers and inorganic compounds, and mixtures of polymers and ceramic materials.

The bumper assembly can be made by injection molding techniques. Alternatively, each layer can be made separately and then assembled with the use of spaced to form the bumper assembly. Other techniques such as compression molding or thermoforming can also be used. The present disclosure is not intended to be limited to any particular type of manufacturing techniques.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A bumper assembly in combination with a vehicle for absorbing kinetic energy associated with an impact event, the bumper assembly comprising:
a plurality of spaced apart polymeric layers configured to have a thickness gradation, wherein the thickness gradation consists of having the polymeric layer with the smallest thickness dimension as an initial impact surface.

2. The bumper assembly of claim 1, wherein the polymeric layers and spacers are formed of a polymer selected from a group consisting of thermoplastics, thermosets, elastomers, and combinations thereof.

3. The bumper assembly of claim 1, further comprising a metal beam to which the bumper assembly is attached, wherein largest thickness dimension faces the metal beam.

4. The bumper assembly of claim 1, wherein the polymeric layer comprises polycarbonate-ABS blends, polycarbonate-poly(butylene terephthalate) blends, polyphenylene ethers, blends comprising polyphenylene ethers, polyethylenes, polyalkylenes, polycarbonates, polyamides, olefin polymers, polyesters, polyestercarbonates, polysulfones, polyethers, polyetherimides, polyimides, silicone polymers, acrylates, mixtures of the foregoing polymers with elastomers, copolymers of the foregoing polymers, and mixtures thereof.

5. The bumper assembly of claim 4, further comprising glass fibers, carbon fibers, aramid fibers, carbon nanotubes, metal powders, metals, intermetallics, clays, ceramics, and mixtures thereof.

6. The bumper assembly of claim 1, wherein the plurality of spaced apart polymeric layers comprise a first set of spaced apart layers having a first thickness dimension, and at least one additional second set of spaced apart layers having a second thickness dimension, wherein the first thickness dimension is less than the second thickness dimension.

7. A bumper assembly in combination with a vehicle for absorbing kinetic energy associated with an impact event, the bumper assembly comprising:
a plurality of spaced apart polymeric layers configured to have a modulus property and/or Poisson's ratio gradation, wherein the modulus property and/or Poisson's ratio gradation consists of having the polymeric layer with lowest modulus property and/or the highest Poisson's ratio as an initial impact surface.

8. The bumper assembly of claim 7, wherein the polymeric layers and spacers are formed of a polymer selected from a group consisting of thermoplastics, thermosets, elastomers, and combinations thereof.

9. The bumper assembly of claim 7, further comprising a metal beam to which the bumper assembly is attached, wherein largest thickness dimension faces the metal beam.

10. The bumper assembly of claim 7, wherein the polymeric layer comprises polycarbonate-ABS blends, polycarbonate-poly(butylene terephthalate) blends, polyphenylene ethers, blends comprising polyphenylene ethers, polyethylenes, polyalkylenes, polycarbonates, polyamides, olefin polymers, polyesters, polyestercarbonates, polysulfones, polyethers, polyetherimides, polyimides, silicone polymers, acrylates, mixtures of the foregoing polymers with elastomers, copolymers of the foregoing polymers, and mixtures thereof.

11. The bumper assembly of claim 10, further comprising glass fibers, carbon fibers, aramid fibers, carbon nanotubes, metal powders, metals, intermetallics, clays, ceramics, and mixtures thereof.

12. The bumper assembly of claim 1, wherein the plurality of spaced apart polymeric layers comprise a first set of spaced apart layers having a first modulus property, and at least one additional second set of spaced apart layers having a second modulus property, wherein the first modulus property is less than the second modulus property.

13. A method for absorbing kinetic energy from an impact event on a bumper assembly of a vehicle, the method comprising:
configuring the bumper assembly to have a plurality of spaced apart polymeric layers and sequentially arranged to have a selected one of a thickness gradation, a poisson's ratio gradation, a flexural modulus gradation and combinations thereof, wherein the thickness gradation consists of positioning the polymeric layer with the smallest thickness dimension as an initial impact surface and wherein the modulus property and/or Poisson's ratio gradation consists of having the polymeric layer with lowest modulus property and/or the highest Poisson's ratio as an initial impact surface: and
absorbing energy from an impact event on the impact surface.

14. The method of claim 13, wherein the polymeric layers and spacers are formed of a polymer selected from a group consisting of thermoplastics, thermosets, elastomers, and combinations thereof.

15. The method of claim 13, further comprising a metal beam to which the bumper assembly is attached, wherein largest thickness dimension faces the metal beam, wherein the layer with the lowest Poisson's ratio faces the metal beam, and wherein the layer with the highest flexural modulus property faces the metal beam.

16. The method of claim 13, wherein the polymeric layer comprises polycarbonate-ABS blends, polycarbonate-poly(butylene terephthalate) blends, polyphenylene ethers, blends comprising polyphenylene ethers, polyethylenes, polyalkylenes, polycarbonates, polyamides, olefin polymers, polyesters, polyestercarbonates, polysulfones, polyethers, polyetherimides, polyimides, silicone polymers, acrylates, mixtures of the foregoing polymers with elastomers, copolymers of the foregoing polymers, and mixtures thereof.

17. The method of claim 16, further comprising glass fibers, carbon fibers, aramid fibers, carbon nanotubes, metal powders, metals, intermetallics, clays, ceramics, and mixtures thereof.

18. The method of claim 13, wherein the plurality of spaced apart polymeric layers comprise a first set of spaced apart layers having a first thickness dimension, and at least one additional second set of spaced apart layers having a second thickness dimension, wherein the first thickness dimension is less than the second thickness dimension.
